(19) United States
(12) Patent Application Publication
(10) Pub. No.: US 2010/0025429 A1
(43) Pub. Date: Feb. 4, 2010

(54) Three Seal Sachet With A Dispensing Device

(76) Inventors: Colin Dennis Ager, Cambridge (GB); James Richard Burfiend, Maidstone (GB); Peter David Cauwood, Cambridge (GB); Alan John Edward Cucknell, Cambridge (GB); Keith Paul Thompson, Cambridge (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/533,023

(22) Filed: Jul. 31, 2009

(30) Foreign Application Priority Data
Jul. 31, 2008 (EP) 08161590.8

(51) Int. Cl. B65D 35/00; B65B 43/02; B31B 1/26; B31B 1/62

(52) U.S. Cl. 222/92; 53/452; 493/231; 493/264; 222/107

(57) ABSTRACT

A three seal sachet and method of manufacturing the sachet. The sachet includes a film having first and second longitudinal sheet edges and opposed first and second sheet faces. The film is folded to form opposed first and second sachet faces where the film is sealed to itself along marginal portions of the first and second longitudinal sheet edges on the first sheet face thereby forming a tube with a longitudinal seal on the second sachet face. First and second transverse seals bond the film along the marginal portions of the first and second transverse edges of the sheet, thereby closing the tube at each end. The sachet also includes a dispensing device disposed on the first or second face. The disposed device includes a flange which is inserted into the first sachet face and secures the device to the sachet and a dispensing orifice enabling product to be dispensed from the sachet.

### FIELD OF THE INVENTION

The present invention relates to a three seal sachet with a dispensing device located on the front face. The sachet is useful for packaging and dispensing oral care compositions, amongst others.

### BACKGROUND OF THE INVENTION

Three seal sachets, also known as stick packs, have been utilized in personal care products, pharmaceuticals, food products, and cosmetics for many years.

PCT application WO2003066472 discloses a sachet providing improved child resistance in a package form which has advantages in dispensing of the product since, with a fin seal along one face of a pack it has been found that the package holds a better three dimensional shape and provides easier pouring than a flat sachet with seals along all four sides. EP1544125 and U.S. Pat. No. 6,352,364 also disclose stick packs with a tear opening. JP2003095333 further describes a stick package for packing contents such as foodstuffs and medicine. Patent applications disclose sachets for dentifrice. WO2001087736 discloses a dual chamber sachet that uniformly dispenses the substances from each chamber when the sidewalls of the sachet are depressed and JP5112366 discloses a laminated container made of a single, long sheet of laminated synthetic resin. However, neither of these applications has a dispensing device. PCT application WO2005000079 discloses a flexible pouch, for use in a personal hygiene device, with a spout element, enclosed within a transverse seal, for connection to a pump. PCT application WO199856685 discloses a sachet with a nozzle secured to the sachet for use as a toothpaste holder.

The present invention provides a dentifrice packaging with a dispensing fitment on the front face of the sachet to enable the product to be squeezed out of the sachet. This provides consumers with a lower cost alternative to tubes for dentifrice packaging. Putting the dispensing device on the face of the pack moves away from the traditional sachet feel and it gives advantages to the consumer in terms of appearance, handling and dispensing, allowing easy control and maximizing usage of the paste.

### SUMMARY OF THE INVENTION

The invention provides a three seal sachet comprising
a) a film, comprising opposed first and second longitudinal sheet edges and opposed first and second sheet faces, which is folded to form opposed first and second sachet faces where the film is sealed to itself along marginal portions of the first and second longitudinal sheet edges on the first sheet face thereby forming a tube with a longitudinal seal on the second sachet face;
b) first and second transverse seals bonding together the film along the marginal portions of the first and second transverse edges of the sheet, thereby closing the tube at each end; characterised in that

on the first or second sachet face there is a dispensing device wherein the dispensing device comprises
i) a flange which is inserted into the first sachet face and secures the device to the sachet
ii) a dispensing orifice, enabling the product to be dispensed from within the sachet.

The invention further relates to a method of manufacturing the three seal sachet.

### BRIEF DESCRIPTION OF THE DRAWINGS

FIG. 1 shows a three seal sachet, with a dispensing device according to a first embodiment of the invention.

FIG. 2 shows the longitudinal fin seal on the second sachet face of the first embodiment shown in FIG. 1.

FIG. 3 shows a second embodiment of the invention, wherein the sachet is encased in a sleeve.

FIG. 4 shows a third embodiment wherein the longitudinal sides of the sachet are not enclosed in the sleeve.

FIG. 5 shows a more detailed view of the dispensing device.

FIG. 6 shows machinery for making the sachet of the invention.

FIG. 7 shows a three seal sachet with an end fitment enclosed in a sleeve.

### DETAILED DESCRIPTION OF THE INVENTION

The invention relates to a three seal sachet incorporating a dispensing device on face thereof. The three seal sachet comprises a film which is folded to form a longitudinal seal to turn it into a tube with first and second sachet faces, and transverse seals at the first and second transverse edges of the sheet. The transverse seals close the tube and form an inner volume capable of containing and protecting a composition until the sachet or dispensing device is opened.

Typically the film is a laminate: a multi-layer structure comprising two or more layers bonded to each other, typically using an adhesive between the layers, although an adhesive is not always necessary. Layers can be co-extruded such that they form a bond with each other without the use of any adhesive. The structure can use many layers and can be a combination of co-extruded and adhesive bonded layers. Typically the laminate is three layers plus adhesive comprising: a product contact layer, an external layer upon which the product information is printed and a barrier layer between the product and external layer which provides the necessary protection to the product from moisture, oxygen, flavour and volatile actives. Additional layers can be used for specific barrier requirements. For example: to increase the rigidity of the sachet in a cost effective manner, to improve sealing characteristics of the sachet, or to improve aesthetics through visual appearance or tactile sensation.

The product contact layer is typically polyethylene (PE) with an additive of 3-5% ethylene vinyl acetate (EVA) to aid sealing. Specialist sealing layers can be used, for example, Surlyn®, which is an ethylene based resin copolymerised with carboxyl groups. The barrier layer can be selected from aluminium, aluminium oxide, silica, ethylene-vinyl alcohol copolymer or other materials known in the art.

The film can also be a monolayer. Suitable materials for a monolayer include polyvinylchloride (PVC), PE, polypropylene (PP) and polyethylenetheraphthalate (PET). The longitudinal seal is a lap seal or a fin seal, preferably a fin seal, located on the second sachet face. A lap seal is formed when the first longitudinal sheet edge on the first sheet face is sealed to the marginal portion of the second longitudinal sheet edge on the second sachet face or vice versa. To form a fin seal, the film is sealed to itself along the marginal portions of the first and second longitudinal sheet edges on the first sheet face. The use of a fin seal allows the external and internal layers of the laminate to be different as in a fin seal execution the same layer of the laminate is sealed to itself. This is important as layers of different material do not bond well to each other. The use of a fin seal thus allows use of alternate external layers to meet requirements of aesthetics and performance through use of stiffer or shinier materials such as PET, PP or polyamide (PA) or lower cost materials such as 100% PE without EVA or other sealant additives. This can have cost saving benefits. In some executions specific high cost product contact/barrier properties may be required which would only be needed on one side of the laminate in fin seal executions but may be needed on both sides of the laminate in a lap seal execution. The use of a fin seal also gives manufacturing advantages over a lap seal by keeping transferred heat away from the composition during sealing. The fin seal is also able to be supported by the sealing machinery enabling stability and fast processing.

The longitudinal seal is formed where the film is sealed to itself along marginal portions of the first and second longitudinal sheet edges on the first sheet face. Heat sealing is preferred. Where the longitudinal seal is a fin seal, it will preferably be folded against the second sachet face so that it is unobtrusive. This is more appealing to the consumer than visible side seals. The width of the seals is generally from 1 to 15 mm, preferably from 2 to 8 mm and more preferably from 4 to 6 mm.

On the first or second sachet face there is a dispensing device. The dispensing device comprises: a flange which is inserted into the first or second sachet face, preferably by heat sealing through a hole in the laminate, and secures the device to the sachet and a dispensing orifice which enables the product to be dispensed from within the sachet. The flange can be any shape which provides a surface or area sufficient to fix it to the film. Preferably the flange does not have sharp edges or corners. The dispensing orifice preferably has a re-sealable closure which can be a flip cap, a screw cap or a self closing valve, examples of which include slit valves and burst valves.

The dispensing device is preferably located on the first sachet face. The dispensing device can be located at any position on the sachet face but is preferably located adjacent to the first transverse seal in the centre of the first sachet face. Typically the edge of the flange is located 2 to 10 mm from the edge of the transverse seal. The dispensing device enables the user to squeeze the product from directly behind the spout. The reclosable means allows multiple mess free dosing. The sachet can be completely flattened to ensure maximum product usage. The transverse seals can be shaped to any form, for example perpendicular to the longitudinal seal or curved to follow the contour of the dispensing device.

The sachet can be designed to hold a wide variety of volumes. Typically for an oral composition, these would be between 25 ml and 175 ml. For a 25 ml sachet the approximate length is 90 mm and the width 25 mm. For a 100 ml sachet the approximate length is 180 mm and the width 50 mm. For a 175 ml sachet the approximate length is 270 mm and the width 62.5 mm.

The sachet can be encased in a sleeve. This can be a plastic sleeve, typically PP, PE or PET, although any commercially available resin which can be formed into a sheet format can be utilised. The sleeve can also be a cardboard sleeve which can have waterproof protection applied typically by varnish or a laminated plastic surface. The rigidity of the sleeve provides mechanical stability to the sachet, allowing the sachet to be formed from very thin film, reducing the cost. With such a thin film the sleeve also provides a means of spreading the pressure when squeezing the sachet to dose the product. The sleeve provides a presence on shelf, in store, similar to that of a carton, allowing stacking on shelf and allowing consistent presentation of branding and claims to consumers.

The three seal sachet can be used to package creams, pastes, liquids and gels. These can include cosmetic, medicinal, foodstuff and cleaning compositions. Preferably the sachet is used to package an oral care composition such as a toothpaste.

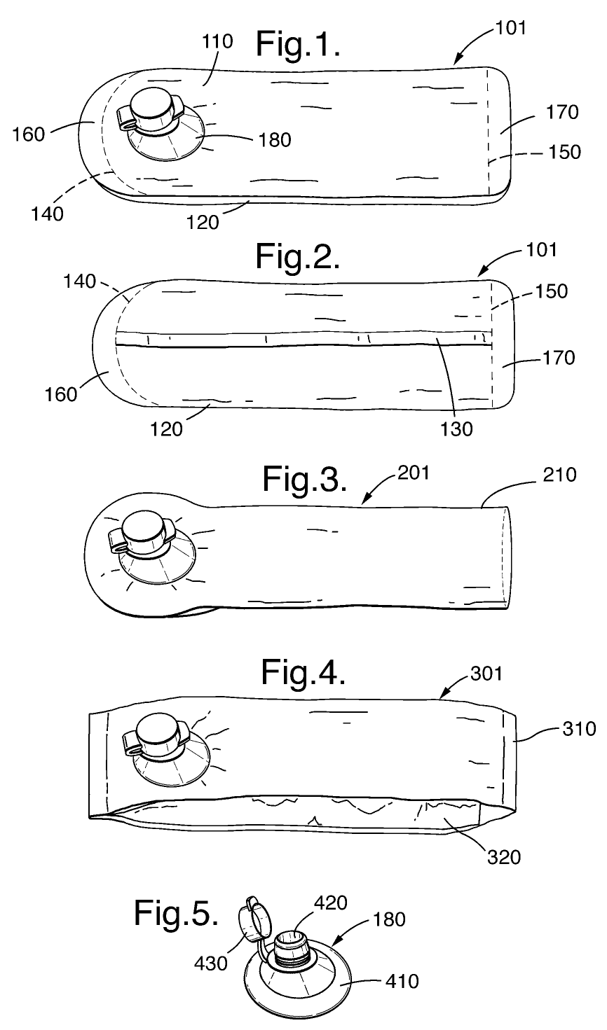

The present invention is now described with reference to the accompanying drawings. A first embodiment, as detailed in FIG. 1, of the invention is a three seal sachet 101. The three seal sachet comprises a laminate film which is folded to form a longitudinal seal to turn it into a tube with first 110 and second 120 sachet faces, and transverse seals 140 and 150 at the first 160 and second 170 transverse edges of the sheet. The transverse seals close the tube and form an inner volume capable of containing and protecting an oral care composition until the sachet is opened.

The film is a three layer aluminium barrier laminate. The product contact layer is PE, the barrier layer is aluminium at a thickness of 9 to 12 μm which gives a barrier for gases, moisture, flavour and fragrance and the external layer is PE on which the brand and product information are printed. Further options for this embodiment can include changing the outer layer to PA to increase the stiffness or to PET to give a stiffer, shinier finish or adding these layers in addition to the PE. A further possibility for this embodiment is to use a plastic barrier laminate where ethylene-vinyl alcohol copolymer (EVOH) is the barrier layer. This can be supplied as a three layer laminate with both sides being coated, typically with PE. This allows a flexible deformation so that the sachet will return to its original shape once squeezed.

Referring to FIG. 2, the longitudinal seal is a fin seal 130, located on the second sachet face and is 4 mm wide. The longitudinal fin seal is folded against the second sachet face.

The dispensing device 180 is located on the first sachet face adjacent to the first transverse seal in the centre of the first sachet face. Referring to FIG. 5, the dispensing device comprises: a circular flange 410 which is inserted into the first sachet face, preferably by heat sealing through a hole in the laminate, and a dispensing orifice 420. The dispensing device has a flip cap 430.

The first transverse edge and first transverse seal of the sachet are in an arch, following the contour of the flange of the dispensing device. The sachet is designed to hold 100 ml of an oral composition and has a length of 180 mm and a width of 50 mm. The transverse seals are 8 mm from the transverse edge.

In a second embodiment of the invention 201, shown in FIG. 3, the sachet is encased in a sleeve 210. The sleeve is a cardboard sleeve with waterproof protection. In this particular embodiment of the invention the sleeve encloses the longitudinal sides of the sachet and follows the contours of the flange. The laminate is a two layer metalized laminate. The inner layer is PE upon which a microscopic layer of aluminium, aluminium oxide, or silica is deposited through vapour deposition. This gives the benefits of a flexible film with high barrier properties. To cover risks of fractures to the metalized layer an additional layer of barrier material can be used.

In a third embodiment 301, shown in FIG. 4, similar to the second embodiment, the first transverse edge and first transverse seam are perpendicular to the longitudinal seam. In this embodiment the sleeve 310 does not enclose the longitudinal sides of the sachet 320 but does enclose the transverse sides of the sachet.

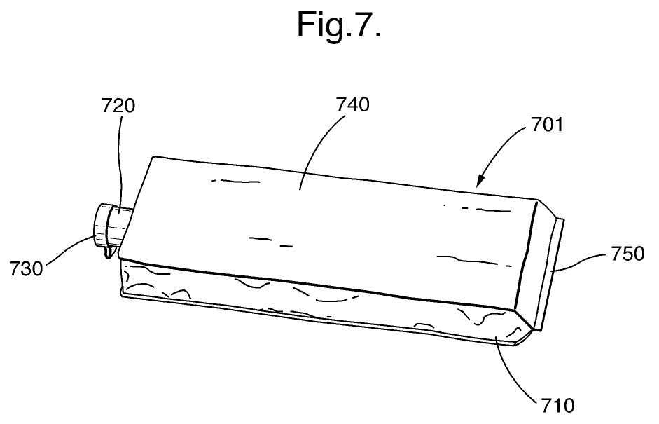

Other sachets enclosed in sleeves are known in the art, for example in applications US20030002755 and WO2007028647. It would be possible to insert a fitment into the transverse seal, an example of which, not within the scope of the present invention, is shown in FIG. 7. The package 701 comprises a three seal sachet 710 with an end fitment 720, including a cap 730, enclosed in a cardboard sleeve 740 where the second transverse seal 750 is not enclosed in the sleeve.

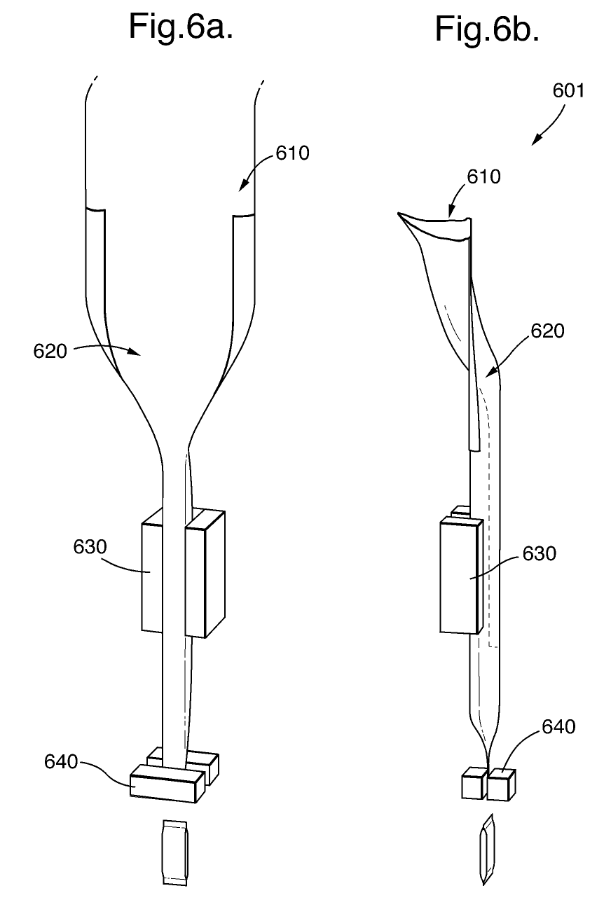

Referring to FIGS. 6a and 6b, the sachet of the invention can be manufactured using a machine 601 designed to form and fill three seal sachets. The film is fed from a reel and fits around a feed tube 620. At this point a hole of suitable diameter, shape and size is cut to accommodate the dispensing fitment in the film. Following this, the dispensing device is inserted into the film. Ideally both the cutting and inserting are done using a continuous motion system, for example, using rotary drum cutters, although a static system is also conceivable. The dispensing device is secured in place through heat sealing, typically by heated seal plates or hot air, or some other mechanical means. The profile of the flange closely resembles that of the feed tube and therefore does not interfere with subsequent manufacturing steps. The composition to be packaged by the sachet enters the feed tube via a hopper 610 and passes down the feed tube. Seal jaws 630 and 640 move up and down along the length of the film to pull the film through the machine. Longitudinal jaws 630 form the longitudinal seam and transverse jaws 640 form the transverse seams. In a further embodiment the longitudinal seal can be formed by rotating jaws. The longitudinal seal is preferably a fin seal which gives manufacturing advantages over a lap seal by keeping transferred heat away from the feed tube. The fin seal is able to be supported by the longitudinal jaws enabling stability and fast processing. The transverse jaws incorporate a cutting blade. On each closure of the transverse jaws, the bottom of the second sachet is sealed at the same time as the top of the first sachet and a cut is made between the two sachets. Alternatively, the transverse jaws can incorporate a perforating blade which allows the formation of a continuous strip of sachets which can be useful for some trade outlets.

In an alternative execution the dispensing device could be inserted into the film before the sachets are passed into a separate machine by mechanical means, which fills the sachet with the composition and forms the longitudinal and transverse seals. In a further execution, the hole for the dispensing device can be made on one machine, and the dispensing device inserted in a second machine which further fills and seals the sachet.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean about “40 mm”.

Every document cited herein, including any cross referenced or related patent or application, is hereby incorporated herein by reference in its entirety unless expressly excluded otherwise limited. The citation of any document is not an admission that it is prior art with respect to any invention disclosed or claimed herein or that it alone, or in any combination with any other reference or references, teaches, suggest or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A three seal sachet comprising:
a) a film, comprising opposed first and second longitudinal sheet edges and opposed first and second sheet faces, which is folded to form opposed first and second sachet faces where the film is sealed to itself along marginal portions of the first and second longitudinal sheet edges on the first sheet face thereby forming a tube with a longitudinal seal on the second sachet face;
b) first and second transverse seals bonding together the film along the marginal portions of the first and second transverse edges of the sheet, thereby closing the tube at each end;
on the first or second sachet face there is a dispensing device wherein the dispensing device comprises
i) a flange which is inserted into the first sachet face and secures the device to the sachet
ii) a dispensing orifice enabling a product to be dispensed from within the sachet.

2. The sachet of claim 1 wherein the film is a laminate.

3. The sachet of claim 2 wherein the laminate comprises at least one layer comprising at least one material selected from polyethylene, ethylene vinyl acetate, polyvinylchloride, polypropylene, polyethylenetheraphthalate, polyamide, aluminium, aluminium oxide, ethylene-vinyl alcohol copolymer, silica, and mixtures thereof.

4. The sachet of claim 3 comprising a product contact layer which includes polyethylene, a barrier layer which includes aluminium, and an external layer which includes polyethylene.

5. The sachet of claim 1 wherein the longitudinal seal is a fin seal.

6. The sachet of claim 5 wherein the longitudinal seal is folded along the second sachet face.

7. The sachet of claim 1 wherein the dispensing device is located on the first sachet face.

8. The sachet of claim 7 wherein the dispensing device is located adjacent to the first transverse seal in the centre of the first sachet face.

9. The sachet of claim 1 wherein the sachet is enclosed in a sleeve.

10. The sachet of claim 9 wherein the sleeve is made from polypropylene, polyethylene, polyethylenetheraphthalate, or a resin, or cardboard.

11. The sleeve of claim 10 which is made from cardboard and has a waterproof protection, preferably selected from varnishes or laminated plastic surfaces.

12. The sachet of claim 8 wherein the first transverse edge and first transverse seam follow the contour of the flange of the dispensing device.

13. The sachet of claim 1 wherein the sachet contains a toothpaste.

14. A method of packaging a composition in the sachet of claim 1, the method comprising the steps of making a hole in the film, inserting the dispensing device into the film and securing it, packaging the composition into the sachet and forming the longitudinal and transverse seals, wherein the dispensing device is not enclosed within a transverse seal.

15. A method of making a three seal sachet containing a fluid composition comprising:
a) providing a film comprising opposed first and second longitudinal sheet edges and opposed first and second sheet faces;
b) making a hole in the film;
c) inserting and securing a dispensing device into a hole in the film;
d) folding the film to form opposed first and second sachet faces where the film is sealed to itself along marginal portions of the first and second longitudinal sheet edges on the first sheet face thereby forming a tube with a longitudinal seal on the second sachet face;
e) bonding together the marginal portions of the first and second transverse edges of the sheet to form first and second transverse seals, thereby closing the tube at each end; and
f) packaging a composition into the sachet.
